(19) United States
(12) Patent Application Publication
(10) Pub. No.: US 2013/0069410 A1
(43) Pub. Date: Mar. 21, 2013

(54) SYSTEM FOR RESTRAINING ARTICLES IN A VEHICLE

(71) Applicant: Stuart Ian Smith, Oakton, VA (US)

(72) Inventor: Stuart Ian Smith, Oakton, VA (US)

(21) Appl. No.: 13/235,384

(22) Filed: Sep. 18, 2011

(51) Int. Cl. B60N 2/36; B60N 2/20; B60N 2/30; B60P 7/135

(52) U.S. Cl. 297/354.1; 410/121

(57) ABSTRACT

An article containment system is provided for restricting the movement of articles positioned on a support surface of a vehicle. The system includes a plurality of panels configured to be attached to the support surface such that each of the panels is movable from a stowed position to an up position in which the panel is substantially perpendicular to the support surface; a first position maintaining element configured to hold a first panel in the up position and configured to allow the first panel to move to the stowed position; and a second position maintaining element configured to hold a second panel in the up position and configured to allow the second panel to move to the stowed position.

### FIELD OF THE INVENTION

The invention is directed to an apparatus for controlling the location of articles in a vehicle, and, more particularly, to an apparatus for mounting on the back of the seat back of a folding seat in a vehicle.

An example of an application for the invention is a collapsible set of partitions that are mounted to the back of the seat back of a folding seat in a pickup truck or sport utility vehicle.

### BACKGROUND OF THE INVENTION

Many pickup trucks, sport utility vehicles, and other vehicles have seats that fold down flat to create storage space for articles. For example, the rear seats in a crew cab pickup truck often fold down to create a flat surface on which articles can be placed. Especially in full size pickup trucks, this flat surface can be very large. Often articles that are much smaller than the flat surface are placed on the flat surface for transport. These small articles can move significantly during transport due to the lack of constraint imposed on the articles. For example, grocery bags containing groceries can shift and/or tip over during transport, resulting in groceries being strewn about all over the flat surface. This results in the inconvenience of having to put the articles back into the grocery bags after arriving at the destination. In some cases, the articles can be broken or damaged as they move around. Also, in most vehicles there are areas surrounding the flat surface into which the small articles can fall, often resulting in the articles falling onto the ground when the truck doors are opened.

### SUMMARY

The invention recognizes that it is desirable to provide an apparatus or system to control the movement of articles placed on the surface created by the back of seat backs of folding seats in a pickup truck, sport utility vehicle, or other vehicle. The invention recognizes that it is desirable to provide such a system that can or be removed or fold flat while still mounted to the back of the seat back so that the seat back can be returned to its upright position in order for the seat to be used as a seat.

Particular embodiments of the invention are directed to an article containment system for restricting the movement of articles positioned on a support surface of a vehicle. The system includes a plurality of panels configured to be attached to the support surface such that each of the panels is movable from a stowed position in which the panel is either substantially parallel to the support surface or removed from the support surface, and an up position in which the panel is substantially perpendicular to the support surface; a first position maintaining element configured to hold a first panel of the plurality of panels in the up position and configured to allow the first panel to move to the stowed position; and a second position maintaining element configured to hold a second panel of the plurality of panels in the up position and configured to allow the second panel to move to the stowed position. The first position maintaining element is either attached to the first panel or is configured to be attached to the support surface of the vehicle, and the second position maintaining element is either attached to the second panel or is configured to be attached to the support surface of the vehicle.

Other embodiments of the invention are directed to an article containment system for restricting the movement of articles in a vehicle. The system includes a support surface configured to be attached to the vehicle; a plurality of panels configured to be attached to the support surface such that each of the panels is movable from a stowed position in which the panel is either substantially parallel to the support surface or removed from the support surface, and an up position in which the panel is substantially perpendicular to the support surface; a first position maintaining element configured to hold a first panel of the plurality of panels in the up position and configured to allow the first panel to move to the stowed position; and a second position maintaining element configured to hold a second panel of the plurality of panels in the up position and configured to allow the second panel to move to the stowed position. The first position maintaining element is attached to the support surface of the vehicle, and the second position maintaining element is attached to the support surface of the vehicle.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of a system in accordance with an exemplary embodiment of the invention;

FIG. 2 is a perspective view of the embodiment of FIG. 1 with one panel in the stowed position;

FIG. 3 is a perspective view of the embodiment of FIG. 1 with two panels in the stowed position;

FIG. 4 is a perspective view of the embodiment of FIG. 1 with three panels in the stowed position;

FIG. 5 is a perspective view of the embodiment of FIG. 1 with four panels in the stowed position;

FIG. 6 is a perspective view of the embodiment of FIG. 1 with four panels in the stowed position and a cover in place;

FIG. 7 a perspective view of the embodiment of FIG. 1 showing a cover storage compartment;

FIG. 8 a perspective view of an embodiment having a cover and a trim piece;

FIG. 9 is a partial perspective view of a panel in accordance with an embodiment;

FIG. 10 is a partial perspective view of a panel in accordance with an embodiment and a connecting piece;

FIG. 11 is a perspective view of a panel having a telescoping feature;

FIG. 12 is a perspective view of a panel having a telescoping feature;

FIG. 13 is a perspective view of a cover;

FIG. 14 is a perspective view of a system in accordance with an exemplary embodiment of the invention;

FIG. 15 is a partial perspective view of a panel in accordance with an embodiment;

FIG. 16 is a partial perspective view of a panel in accordance with an embodiment;

FIG. 17 is a perspective view of a storage device for holding the panels in a stowed position; and

FIG. 18 is a perspective view of a system in accordance with an exemplary embodiment of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

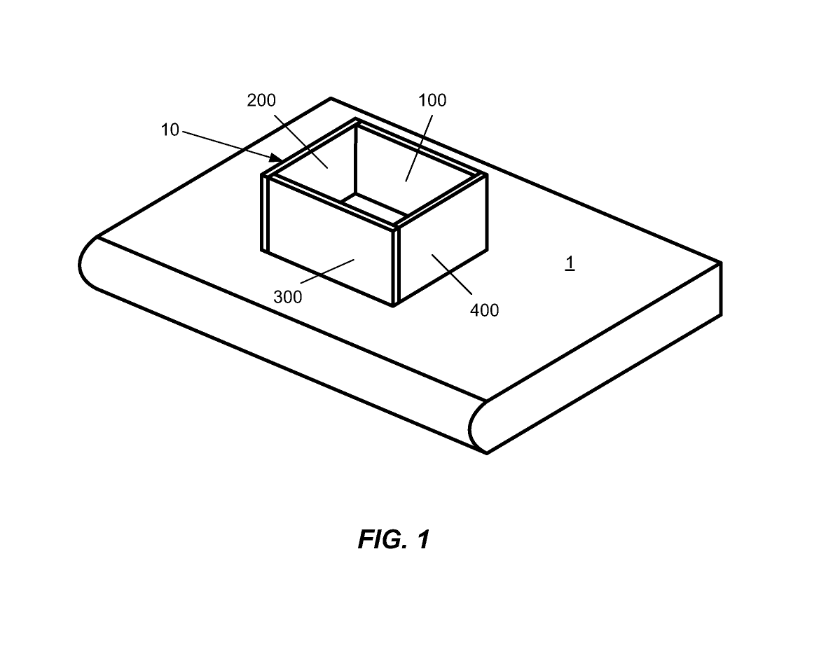

FIG. 1 shows an example of an article containment system 10 in accordance with the invention in a deployed, or in-use, position. System 10 includes a first panel 100, a second panel 200, a third panel 300, and a fourth panel 400 mounted to a support surface 1 of a vehicle. Support surface 1 can be, for example, the back of a foldable seat back in a pickup truck, sport utility vehicle, or other vehicle. Other examples of a support surface to which system 10 can be attached is a cargo area in a sport utility vehicle or other vehicle.

System 10 can be useful in restraining the movement of articles that are much smaller than the support surface.

FIGS. 2-6 show an example of the function of the containment system shown in FIG. 1. FIG. 2 shows fourth panel 400 in the stowed position. In this example, fourth panel 400 has a hinge (not shown) that attaches fourth panel 400 to support surface 1.

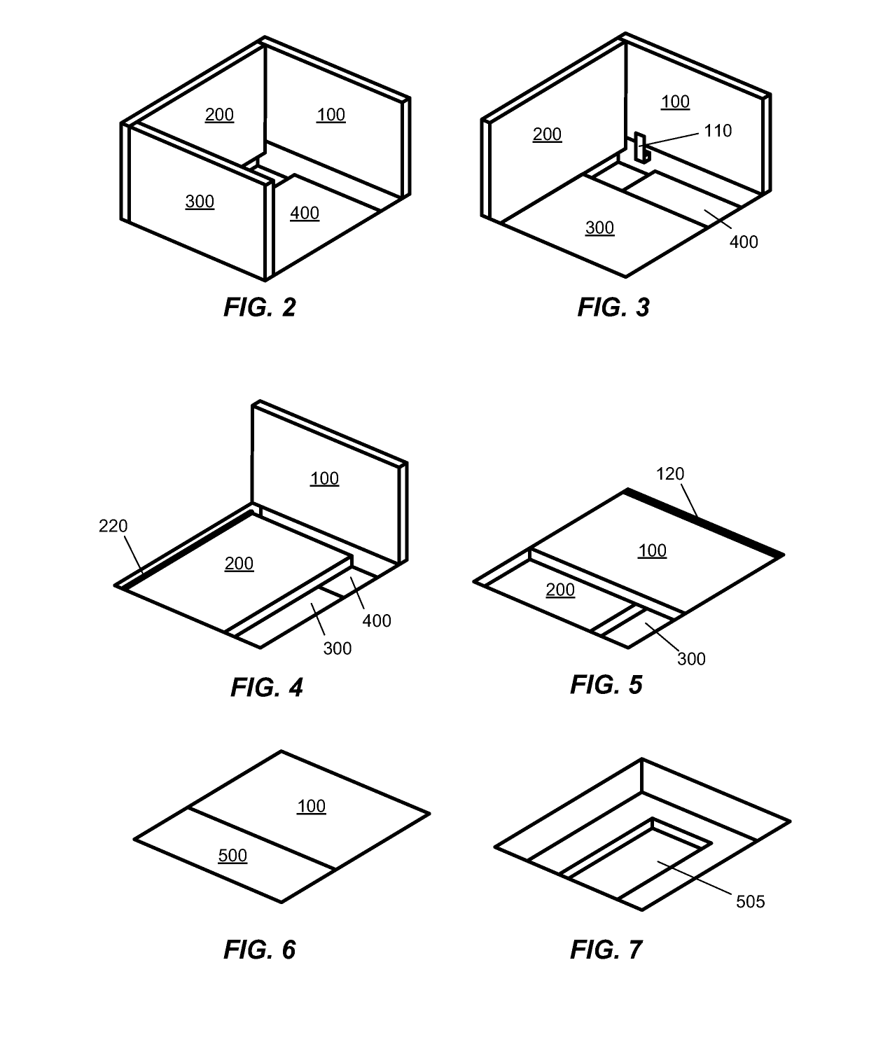

FIG. 3 shows third panel 300 in the stowed position overlapping fourth panel 400. In this example, third panel 300 has a hinge (not shown) that attaches third panel 300 to support surface 1. FIG. 4 shows second panel 200 in the stowed position. In this example, second panel 200 has a hinge 220 that attaches second panel 200 to support surface 1. FIG. 5 shows first panel 100 in the stowed position. In this example, first panel 100 has a hinge 120 that attaches first panel 100 to support surface 1. As can be seen from FIGS. 2-5, the panels pivot from the deployed position to the stowed position on their respective hinges such that they lay on top of each other.

In this example, first panel 100 is flush with the upper surface of support surface 1 when it is in the stowed position. FIG. 6 shows a cover 500 in place beside first panel 100 to fill in the portion of the storage recess that is not covered by first panel 100. FIG. 7 shows a cover recess 505 located in the bottom of the storage recess. Cover recess 505 holds cover 500 when the panels are in the deployed position.

FIG. 3 shows a clip 110 that can be used to hold first panel 100 in the deployed position. Other devices and methods can be used to hold the panels in the deployed position. For example, hinge 120 can be a sprung hinge that urges first panel 100 into the deployed position. Each panel can have a similar hinge such that when first panel 100 is deployed, the remaining three panels spring into the deployed position under the force of their hinges. First panel 100 can be held in the stowed position by a friction fit in the storage recess or by some other device or method. The entire system can be recessed in support surface 1 so that cover 500 and first panel 100 are flush with the upper surface of support surface 1.

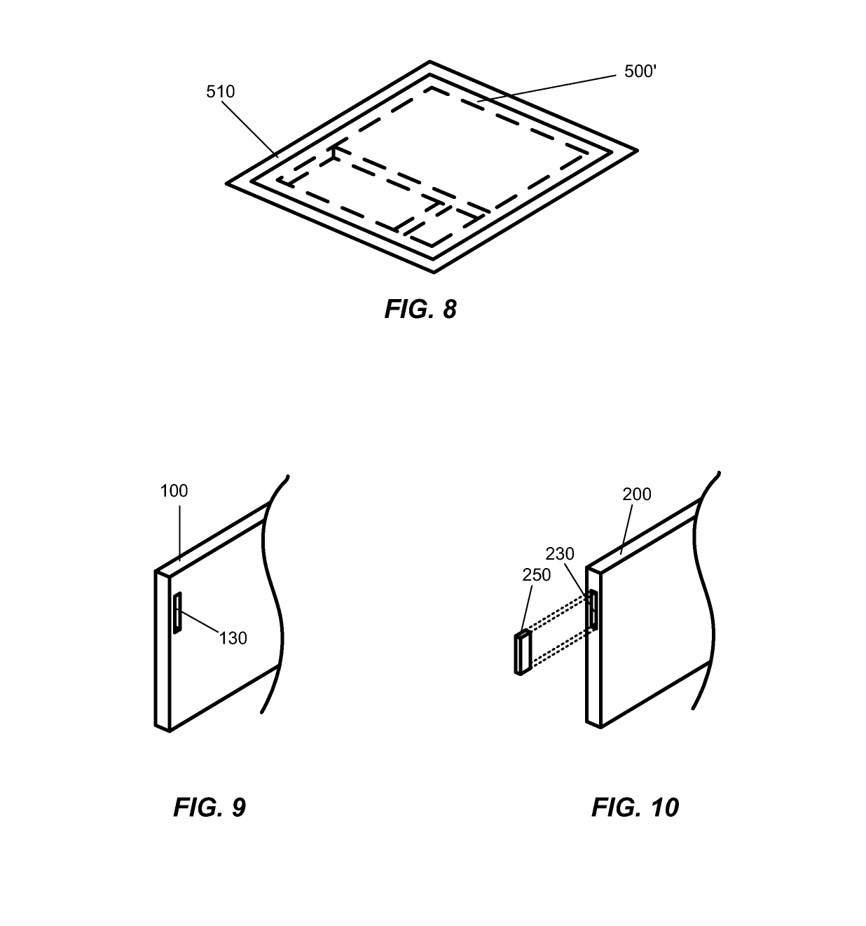

FIG. 8 shows an example of a cover 500′ that covers all of the panels when the panels are in the stowed position. Cover 500′ fits into a frame 510 so that cover 500′ is flush with frame 510. The entire system can be recessed in support surface 1 so that cover 500′ and frame 510 are flush with the upper surface of support surface 1.

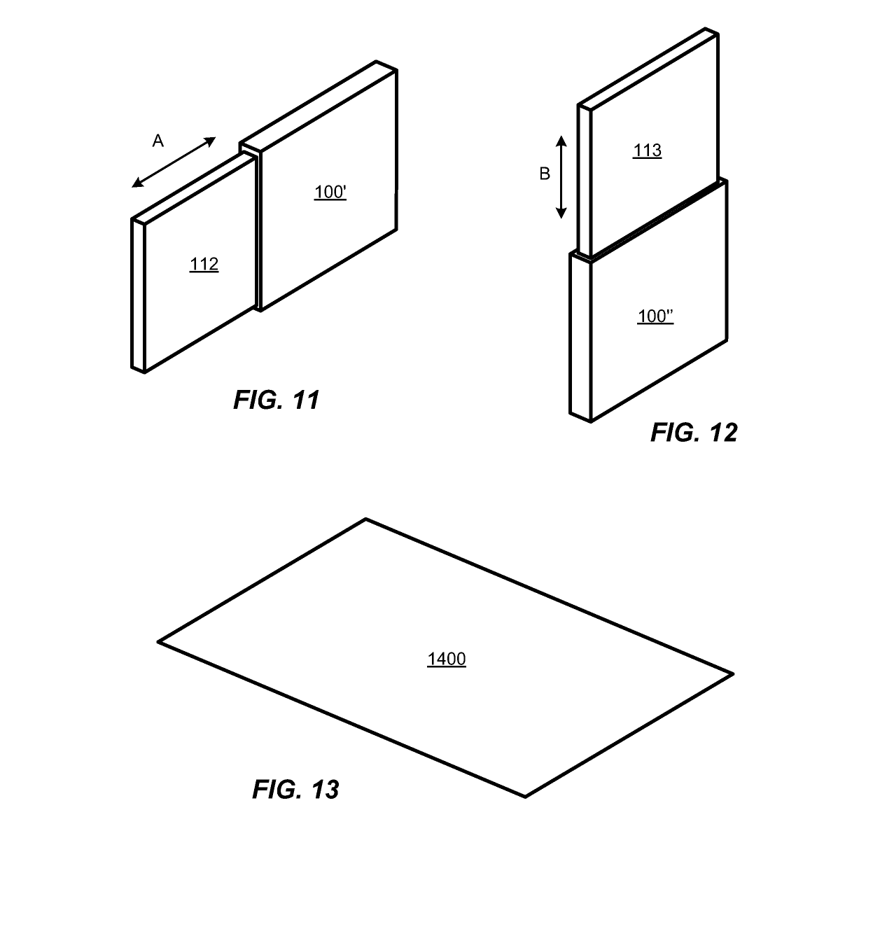

FIGS. 9 and 10 show an example of a coupler system that couples the panels to each other. In this example, one end of a coupler 250 fits in a recess 230 of second panel 200 and the other end of coupler 250 fits into a recess 130 in first panel 100. Coupler 250 can be held in recess 230 and recess 130 by, for example, a friction fit.

FIGS. 11 and 12 show examples of panels 100′ and 100″ that have telescoping members that can be deployed to extend the size of the panels. Panel 100′ has a telescoping panel 112 that can extend horizontally from panel 100′. Panel 100″ has a telescoping panel 113 that can extend vertically from panel 100″.

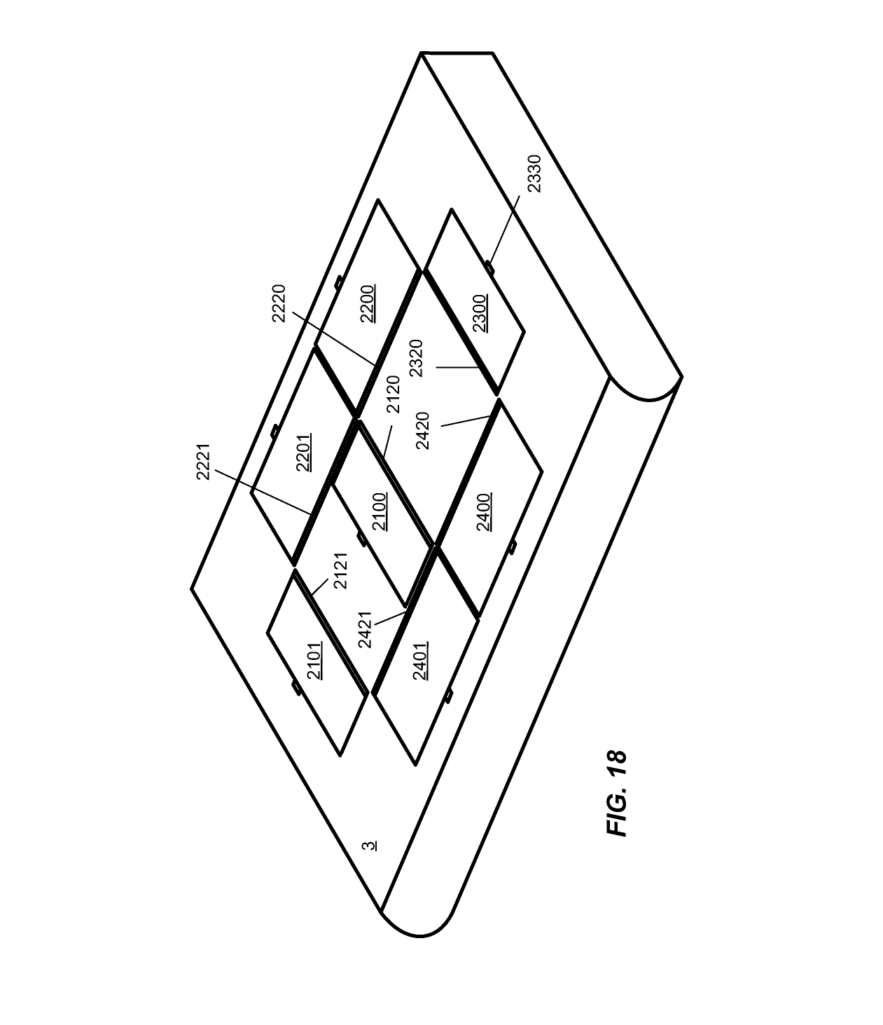

FIGS. 13-17 show an example of an embodiment of the invention in which the panels are not attached to the support surface in the stowed position. In this embodiment, the panels are stored in a panel storage compartment 1400 attached to the body 1500 of the vehicle when the panels are not being used.

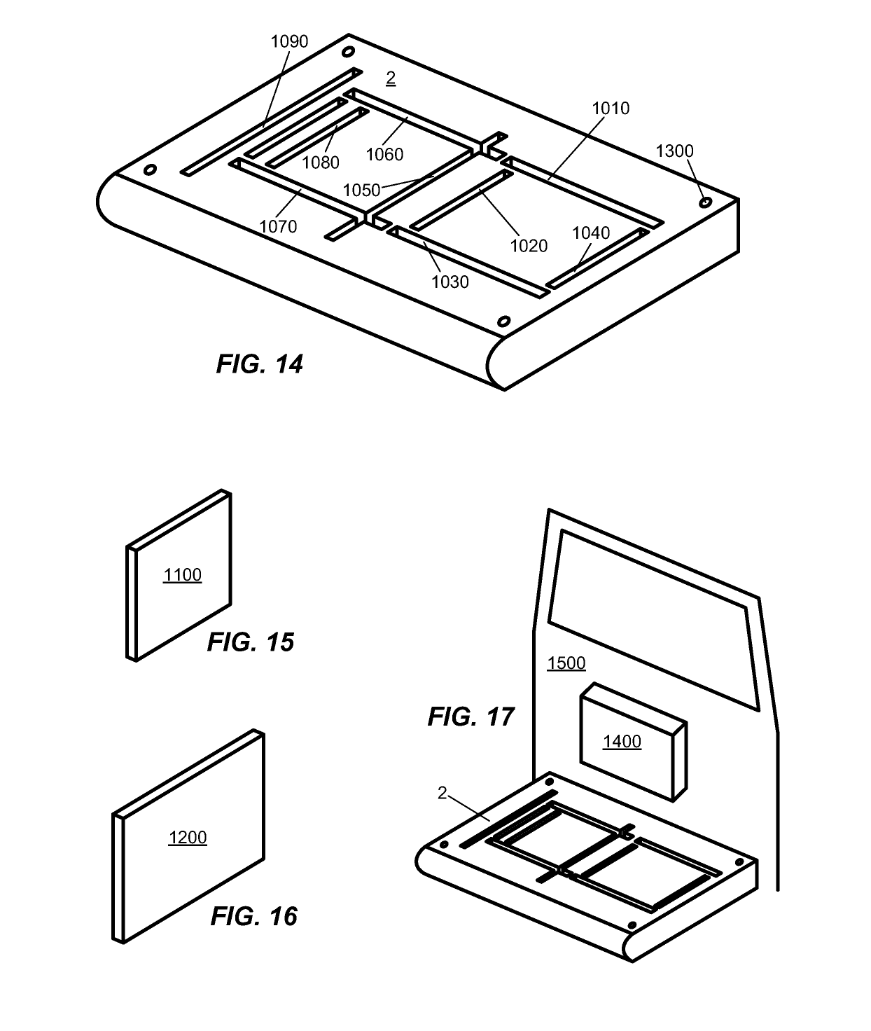

FIG. 14 shows a support surface 2 (in this example, the back of a seat back of the vehicle) having a plurality of recesses 1010, 1020, 1030, 1040, 1050, 1060, 1070, 1080, 1090. The recesses hold panels, for example panels 1100, 1200, in the deployed position in order to form barriers to restrain the articles placed in the support surface. The differing sizes and locations of the recesses and having a plurality of panels of different sizes provides a plurality of different possible configurations in order to restrain articles of different sizes. FIG. 13 shows a cover 1400 that can cover the recesses in support surface 2 when the system is not in use. Cover 1400 can be held in place by, in this example, four cover attachments 1300.

FIG. 18 shows an example of an embodiment of the invention in which the panels are attached to the support surface with hinges and each fold down into the stowed position without overlapping each other. Panel 2100 has a hinge 2120; panel 2200 has a hinge 2220; panel 2300 has a hinge 2320; panel 2400 has a hinge 2420; panel 2101 has a hinge 2121; panel 2201 has a hinge 2221; and panel 2401 has a hinge 2421. Each panel has a recess to enable a user's finger to pry the panel up from the support surface. For example, recess 2330 is provided for panel 2300. The hinges can be sprung hinges that urges the panels into the deployed position. The panels can be held in the stowed position by a friction fit in a storage recess or by some other device or method. Alternately, the panels can rest on top of the support surface in the stowed position.

By providing a plurality of panels, this example provides a system that can form a small restrained area or a larger restrained area.

The examples shown are shown on a single seat back. The system can be on one seat back or multiple seat backs. For example, a split rear seat in a pickup truck can has a separate system on each seat back. Also, an SUV can have a separate system on each seat back and another system (or systems) located on the horizontal surface of the cargo area behind the rear most seat. The telescoping panel shown in FIG. 11 can be used to extend over a gap such as the gap between the two seats of a split rear seat set up.

Although the embodiments shown show four walls being deployed to restrain articles, only one wall or only two walls or only three walls can be deployed to restrain larger articles. A surface of the vehicle, such as a door or other body surface, can be used in conjunction with the panel(s) to restrain the articles.

It is noted that features of one exemplary embodiment may be combined with other embodiments. A non-exclusive example is that telescoping walls may be used with other embodiments, including any of the shown embodiments. Another non-exclusive example is that one or more of the removable walls shown in FIGS. 14-17 can be used with other embodiments, including any of the shown embodiments. Another non-exclusive example is that the cover of FIG. 13 can be used with other embodiments, including any of the shown embodiments.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. An article containment system for restricting the movement of articles positioned on a support surface of a vehicle, the system comprising:
a plurality of panels configured to be attached to the support surface such that each of the panels is movable from a stowed position in which the panel is either substantially parallel to the support surface or removed from the support surface, and an up position in which the panel is substantially perpendicular to the support surface;
a first position maintaining element configured to hold a first panel of the plurality of panels in the up position and configured to allow the first panel to move to the stowed position; and
a second position maintaining element configured to hold a second panel of the plurality of panels in the up position and configured to allow the second panel to move to the stowed position,
wherein the first position maintaining element is either attached to the first panel or is configured to be attached to the support surface of the vehicle, and
the second position maintaining element is either attached to the second panel or is configured to be attached to the support surface of the vehicle.

2. The system of claim 1, wherein
the plurality of panels are configured to be pivotably attached to the support surface such that each of the panels is pivotable relative to the support surface between the stowed position in which the panel is substantially parallel to the support surface, and the up position,
the first position maintaining element is attached to the first panel, and
the second position maintaining element is attached to the second panel.

3. The system of claim 2, further comprising a first retaining element that holds the first panel in the down position.

4. The system of claim 3, wherein the first retaining element is the first position maintaining element.

5. The system of claim 4, wherein at least a portion of the first panel overlaps at least a portion of the second panel when the first panel and the second panel are in the stowed position.

6. The system of claim 2, further comprising a third position maintaining element attached to a third panel of the plurality of panels, the third position maintaining element having a deployed position in which the third position maintaining element holds the third panel in the up position, and a released position in which the third position maintaining element allows the third panel to move to the stowed position.

7. The system of claim 6, further comprising a fourth position maintaining element attached to a fourth panel of the plurality of panels, the fourth position maintaining element having a deployed position in which the fourth position maintaining element holds the fourth panel in the up position, and a released position in which the fourth position maintaining element allows the fourth panel to move to the stowed position.

8. The system of claim 7, wherein at least a portion of the second panel overlaps at least a portion of the third panel when the second panel and the third panel are in the stowed position, and
at least a portion of the third panel overlaps at least a portion of the fourth panel when the third panel and the fourth panel are in the stowed position.

9. The system of claim 2, wherein each of the panels is independently pivotable relative to the support surface between the stowed position and the up position.

10. The system of claim 1, wherein the first panel has a first section and a second section, and the second section slides relative to the first section.

11. The system of claim 10, wherein the second section telescopes into the first section.

12. The system of claim 8, wherein the first panel, the second panel, the third panel, the fourth panel, the first position maintaining element, the second position maintaining element, the third position maintaining element, and the fourth position maintaining element are configured to be attachable to and detachable from the support surface as a single unit.

13. An article containment system for restricting the movement of articles in a vehicle, the system comprising:
a support surface configured to be attached to the vehicle;
a plurality of panels configured to be attached to the support surface such that each of the panels is movable from a stowed position in which the panel is either substantially parallel to the support surface or removed from the support surface, and an up position in which the panel is substantially perpendicular to the support surface;
a first position maintaining element configured to hold a first panel of the plurality of panels in the up position and configured to allow the first panel to move to the stowed position; and
a second position maintaining element configured to hold a second panel of the plurality of panels in the up position and configured to allow the second panel to move to the stowed position,
wherein the first position maintaining element is attached to the support surface of the vehicle, and
the second position maintaining element is attached to the support surface of the vehicle.

14. The system of claim 13, wherein
the plurality of panels are pivotably attached to the support surface such that each of the panels is pivotable relative to the support surface between the stowed position in which the panel is substantially parallel to the support surface, and the up position,
the first position maintaining element is attached to the first panel, and
the second position maintaining element is attached to the second panel.

15. The system of claim 13, wherein the support surface is a rear surface of a movable seat back of the vehicle, the rear surface being a surface opposite a surface of the seat back that is contacted by a back of a user of the seat when the user is seated in the seat, and
the seat back is movable between a usable position in which the seat back is usable as a part of a seat, and a stowed position in which the support surface is substantially horizontal.

16. The system of claim 15, wherein the support surface includes a first recess, and the first panel is positioned within the first recess when the first panel is in the stowed position.

17. The system of claim 16, wherein the support surface includes a second recess,
the second panel is positioned within the second recess when the second panel is in the down position,
the second recess is deeper than at least a portion of the first recess, and
at least a portion of the first panel overlaps at least a portion of the second panel when the first panel and the second panel are in the stowed position.

18. The system of claim 13, wherein the first position maintaining element is a first recess in the support surface of the vehicle,
the second position maintaining element is a second recess in the support surface of the vehicle,
the first panel is held in the up position when the first panel is inserted into the first recess,
the second panel is held in the up position when the second panel is inserted into the second recess,
the first panel is movable to the stowed position when the first panel is removed from the first recess, and
the second panel is movable to the stowed position when the second panel is removed from the second recess.

19. The system of claim 18, further comprising a plurality of first recesses.

20. The system of claim 18, further comprising a panel storage device, the panel storage device holding the plurality of panels in the stowed position and being configured to be attached to the vehicle.
